(19) United States
(12) Patent Application Publication
(10) Pub. No.: US 2005/0008326 A1
(43) Pub. Date: Jan. 13, 2005

(54) Video recording apparatus and method of programming the video recording apparatus to perform timer recording

(75) Inventor: Yutaka Kawada, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/805,537

(22) Filed: Mar. 22, 2004

(30) Foreign Application Priority Data
Apr. 24, 2003 (JP) 2003-120095

(51) Int. Cl. H04N 5/781

(52) U.S. Cl. 386/46; 386/125

(57) ABSTRACT

Programming information is received from a portable terminal of a user via a communication network, and whether recording is possible according to the programming information is judged. If recording is possible, the internal state of the video recording apparatus after being programmed, including the remaining amount of available storage, is acquired, and the data of the internal state is transmitted to a Web server on the communication network. An e-mail indicating that the programming information has been registered, and an URL of the Web server, is sent to the portable terminal of the user. The data of the internal state of the video recording apparatus stored in the Web server is sent to the user in response to an instruction from the user via the communication network.

### CROSS-REFERENCE TO RELATED APPLICATIONS

This application is based upon and claims the benefit of priority from prior Japanese Patent Application No. 2003-120095, filed Apr. 24, 2003, the entire contents of which are incorporated herein by reference.

### BACKGROUND OF THE INVENTION

1. Field of the Invention

The present invention relates to a video recording apparatus capable of communicating via a communication network such as the Internet, and a method of programming the video recording apparatus using the communication network to perform timer recording.

2. Description of the Related Art

A video recording apparatus records data such as video data, audio data, and control data onto a recording medium and reproduces the data from the recording medium. It is programmed to record a desired recording source (program) at a set date and time, at a designed recording rate, and by a designated recording mode. Programming is done by registering video recording apparatus programming information (hereinafter referred to in abbreviated form as programming information), such as the date and time at which recording is to be started, the data and time at which recording is to be stopped, the recording source, the recording mode (audio recording form, presence/absence of a simulcast, and so forth), and the recording rate, into the video recording apparatus through the main unit or its accompanying remote control unit.

In recent years, the date and time at which recording is to be started (broadcast start time), the date and time at which recording is to be stopped (broadcast end time), the broadcast channel, and the like, of a recording source can be pinpointed by inputting a programming code, called a G-code, into a recording apparatus through an input unit such as a remote control unit. Hence, the amount of programming information that needs to be input into a video recording apparatus is reduced.

In addition, a recording apparatus has been developed that permits the recording stop time to be extended in increments of 15 minutes every time an extension setting section provided to the remote control unit or apparatus main unit is operated once. This is done at such a time as when the broadcast time of the program that is being recorded is delayed and the ending time is altered, or when a user has found out before recording is started that an incorrect recording stop time has been input.

Once video recording apparatus programming is carried out, there arises a problem. That is, when a user cannot operate the video recording apparatus directly or through the remote control unit, for example, because he/she has gone outside the home, programming information already input to a video recording apparatus cannot be changed, or that new, additional video recording apparatus programming cannot be carried out. In order to solve this problem, a system has been developed that uses e-mail as the means of sending programming information and the like to a video recording apparatus, as described in a Toshiba's HDD & DVD video recorder manual at http://www.rd-style.com/rdstyle/can/net_navi_{—}02.htm. Such a video recording apparatus allows a user to register programming information into the apparatus by sending e-mail from a celluler telephone.

In the above-described prior art, a user who is at a location away from a video recording apparatus can program the apparatus to perform timer recording using e-mail. However, if the user does not know the recording status or the recording schedule of the video recording apparatus before video recording apparatus programming, the user sometimes cannot program the video recording apparatus to record a program as intended, and must reprogram the video recording apparatus more than once. Not only that, a communication charge is added every time the user receives a confirmation mail after programming the video recording apparatus to record a program.

Furthermore, at the time of programming the video recording apparatus to record more than one program by e-mail from a remote location, although a user is notified of the completion of programming for the recording of the first program, the user cannot check the amount of storage in the video recording apparatus that remains available after the recording of the first program, before programming the video recoding apparatus to record subsequent programs.

### BRIEF SUMMARY OF THE INVENTION

A video recording apparatus according to one embodiment of the present invention communicates with an external apparatus via a communication network and comprises: a recording section which records a broadcast onto a recording medium; a communication control section which controls communication via the communication network; an acquisition section which acquires an internal state of the video recording apparatus including an amount of storage that remains available on the recording medium; and an internal state transmission section which transmits and stores data of the internal state, acquired by the acquisition section, into a server on the communication network using the communication control section, wherein the data of the internal state stored in the server is sent to a user in response to an instruction sent from the user via the communication network.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the structure of a video recording apparatus 1 according to one embodiment of the present invention.

FIG. 2 shows an example of a system whereby a user checks the internal state of the video recording apparatus 1 using a Web server 4 when the user programs the video recording apparatus 1 to record a program.

FIG. 3 is a flowchart showing an example of a process for downloading the recording schedule of the video recording apparatus 1 and programming the video recording apparatus 1 to record a program by e-mail in the system shown in FIG. 2.

FIG. 4 shows an example of the format of an e-mail sent when programming of the video recording apparatus 1 has failed.

FIG. 5 shows an example of the format of an e-mail sent when the video recording apparatus 1 has been successfully programmed.

FIGS. 6A and 6B show examples of the internal state of the video recording apparatus 1.

FIG. 7 is a flowchart showing the operation of the system by which a user sends an e-mail requesting only the data of the internal state of the video recording apparatus 1, and receives the data of the internal state from a Web server.

FIG. 8 shows an example of the format of an e-mail sent when transmission of thee data of the internal state has been requested.

### DETAILED DESCRIPTION OF THE INVENTION

Embodiments of the present invention will now be described in detail with reference to the drawings.

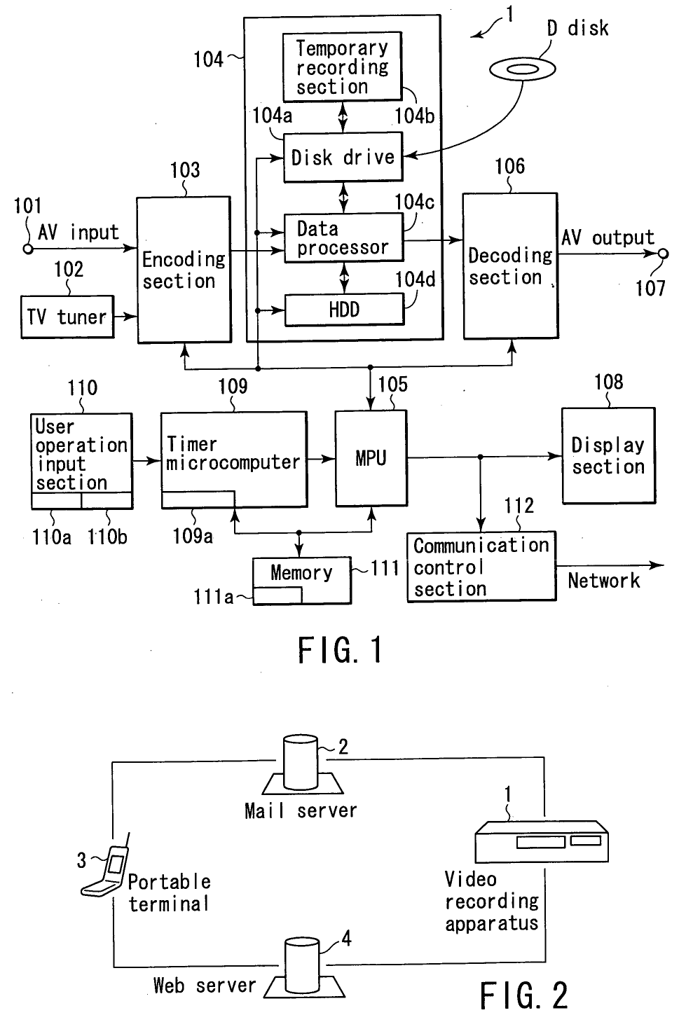

FIG. 1 is a block diagram showing the structure of a video recording apparatus 1 according to one embodiment of the present invention. The video recording apparatus 1 includes a recording and reproducing section 104, and a microcomputer (MPU, i.e., a main control unit) 105. The recording and reproducing section 104 records input information on a designated recording medium and reproduces already recorded information in response to an instruction. The microcomputer 105 controls recording and reproduction operations of the recording and reproducing section 104, and the operation of each section described below.

The recording and reproducing section 104 includes: a disk drive unit 104a capable of recording and reproducing data onto and from a disk D that is manufactured to be in conformity with, for example, the DVD (digital versatile disk) standard; a temporary recording section 104b which serves as a buffering memory capable of temporary storing a certain amount of data that is to be recorded on the disk D loaded in the disk drive unit 104a, or a certain amount of data that has been reproduced from the disk D; a HDD 104d capable of recording a large amount of data; and a data processor 104c.

Under the control of the MPU 105, the data processor 104c supplies to-be-recorded data output from the encoding section 103 to the disk drive unit 104a, or obtains reproduced signals of the disk D from the disk drive unit 104a and supplies them to a decoding section 106; supplies to-be-recorded data output from the encoding section 103 to the HDD 104a, or supplies reproduced signals from the HDD 104a to the decoding section 106; and rewrites management information recorded on the disk D or HDD 104a, or deletes data recorded on the disk D or HDD 104a.

The temporary recording section 104b can be used, more specifically, when the entire storage on the disk has been used up during recording, to temporally store data subjected to recording until the disk D is replaced with a disk with an available storage space. The disk D is a recordable optical disk such as a write-once DVD-R, or rewritable DVD-RAM.

The encoding section 103 encodes and compresses input video signals. The encoding section 103 is connected to an AV input terminal 101 for inputting video signals subjected to recording from the outside, and a tuner 102 capable of receiving video and audio data distributed from data distributors typified by, for example, broadcasting business entities and the like.

The decoding section 106 decodes and decompresses video data output from the recording and reproducing section 104. The decoding section 106 is connected to an AV output terminal 107 for supplying reproduction data, which is obtained by decoding (by the decoding section 106), to a reproduction apparatus such as a TV.

The MPU 105 is connected to a timer microcomputer 109, and the timer microcomputer 109 has a timer circuit (clock unit) 109a used for the time management of the video recording apparatus 1. The timer microcomputer 109 is connected to a user operation input section 110 that accepts an operation (instruction) from a user.

In addition, the MPU 105 is connected to: a display section 108 that displays programming information or the operating status of the main unit of the video recording apparatus 1; a communication control section 112 capable of receiving programming information from the outside and notifying a designated inquirer whether the video recording apparatus 1 can be programmed via a communication network such as the Internet, connection to which is established by telephone lines or CATV lines; and a memory 111 capable of storing programming information and the like. Note that the communication control section 112 is provided in advance with a browser (a piece of application software that allows a user to search for and view information on the network) that is used widely on the network, and a dialer, not shown in the drawings, capable of sending e-mail to the outside under certain conditions, and so forth. Programming information input from the outside via the communication network is registered in a programming information table 111a if the recording of the program identified by the programming information can be recorded.

According to the control program stored in the memory 111, the MPU 105 controls recording, reproduction, and deletion of data with respect to the disk D. In addition, it controls recording operation according to programming information input via the user operation input section 110, display operation using the display section 108, and so forth.

The timer microcomputer 109 manages programming information registered by the user, while monitoring the timer circuit (clock unit) 109a and the programming information table 111a. It outputs a recording start command to the MPU 105 when it is the scheduled time to start recording, and outputs a recording stop instruction to the MPU 105 when it is the scheduled time to stop recording.

Through the user operation input section 110, a user can record and reproduce programs, input programming information, alter programming information, and so forth. In addition, the user operation input section 110 includes a data receiving section 110b that receives control signals transmitted from a remote control terminal not shown in the drawings, and an operation panel 110a capable of accepting direct inputs from a user and outputting control signals to the timer microcomputer 109.

FIG. 2 shows an example of a system by which a user checks the internal state (the recording schedule, the amount of storage that remains available, and so forth) of the video recording apparatus 1 shown in FIG. 1 using a Web server 4 at the time of video recording apparatus programming. The video recording apparatus 1 and a portable terminal 3 are connected to a mail server 2 and the Web server 4 via a communication network such as the Internet.

The portable terminal 3 is an already-existing device capable of communication, such as a celluler telephone, PC (personal computer), PDA (personal digital assistances), or PHS (personal handy-phone system). The Web server 4 is a site on the Internet that is, for example, set up by the manufacturer of the video recording apparatus 1 and can be used by a user free of charge. A user (or the video recording apparatus 1) can access the Web server by identifying the site by the URL (uniform resource locator) that is the Internet address of the Web server and an identification number such as a password.

FIG. 2 shows transmission of an e-mail containing programming information to the mail server (commercial communication control apparatus) 2 from a user using the portable terminal 3. The programming information includes the ID of a broadcasting station, a recording start time, a recording stop time, the rate of recording, and the like. The e-mail is addressed to an address unique to the video recording apparatus 1. The video recording apparatus 1 receives the e-mail from the mail server 2, judges a particular code sequence in the e-mail text to be programming information, and stores the programming information into the memory 111.

The video recording apparatus 1 can be caused to access the mail server 2 when the power to the video recording apparatus 1 is on or when the video recording apparatus 1 is on standby, at time intervals set by a user. When the video recording apparatus 1 is on standby, power is supplied only to the timer microcomputer 109, the MPU 105, the memory 111, and the communication control section 112.

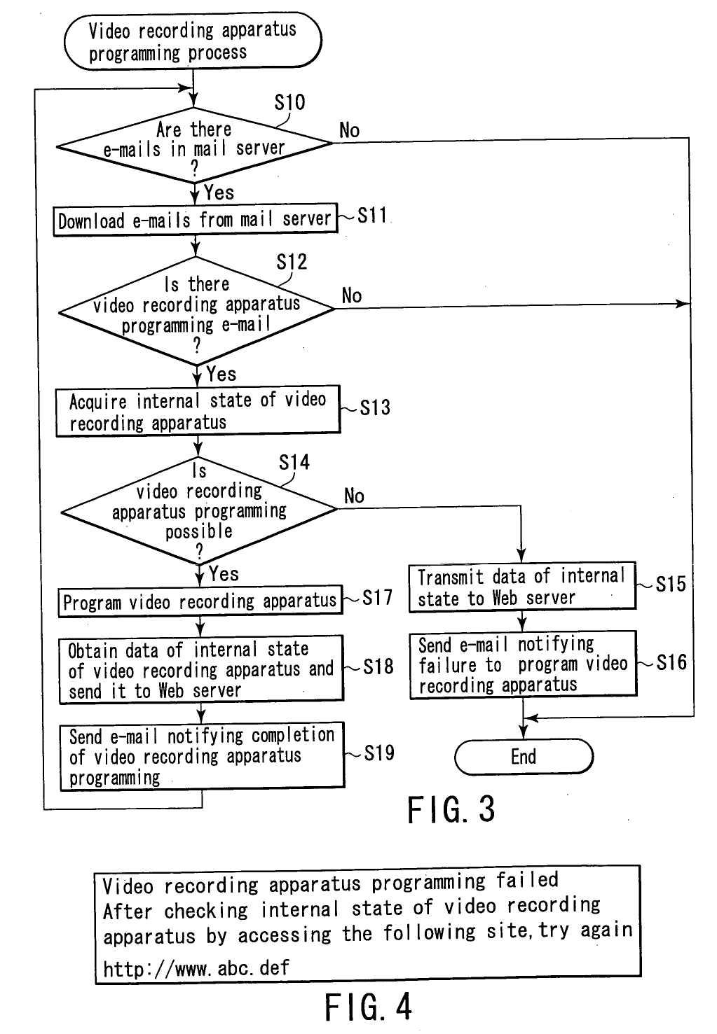

FIG. 3 is a flowchart showing an example of a process for downloading the recording schedule of the video recording apparatus 1 and programming the video recording apparatus 1 to record a program by e-mail using the system shown in FIG. 2.

First, the MPU 105 checks via the communication control apparatus 112 whether e-mails addressed to the video recording apparatus 1 are in a designated mailbox in a pre-designated server (S10). If there are e-mails in the mailbox, they are downloaded from the mailbox (S11). Next, the MPU 105 judges whether the downloaded e-mails include a video recording apparatus programming e-mail (S12). If it is judged that the downloaded e-mails do not include any video recording apparatus programming e-mail, video recording apparatus programming is ended.

If the MPU 105 judges that the downloaded e-mails includes a video recording apparatus programming e-mail (Yes in step S12), it then judges whether the video recording apparatus can be programmed according to the received video recording apparatus programming e-mail. In other words, the MPU 105 acquires the internal state of the video recording apparatus 1, such as the amount of storage that remains available on the disk D or HDD 104d, the number of programs already scheduled to be recorded, and the like (S13), by referring to the management information on the temporary recording section 104b and the disk D or HDD 104d, and the programming information table 111a, and after that, judges whether the video recording apparatus 1 can be programmed to record another program (S14). If the MPU 105 judges that video recording apparatus programming for another program is not possible (No in step S14), it transmits and stores the data of the internal state obtained from the management information on the temporary recording section 104b and the disk D or HDD 104d, and the programming information table 111a into the Web server 4 (S15). In addition, the MPU 105 sends a notification to the user's portable terminal by e-mail about the failure to carry out video recording apparatus programming by e-mail, and the URL of the Web server storing the data of the internal state of the video recording apparatus 1. Then, video recording apparatus programming is ended.

The transfer of the data of the internal state stored in the Web server to the user is carried out when the user accesses the Web server and instructs the transmission of the data of the internal state. Because the data of the internal state is transferred to the user in response to a request, as described above, unnecessary communication can be prevented. Moreover, transmission of the data of the internal state does not cost the user any money. FIG. 4 shows an example of the format of an e-mail sent when video recording apparatus programming by e-mail has failed.

If it is judged that video recording apparatus programming is possible (Yes in step S14), in step S17, video recording programming information is added and registered as stated above into the video recording programming information table 111a of the memory 111 according to the e-mail.

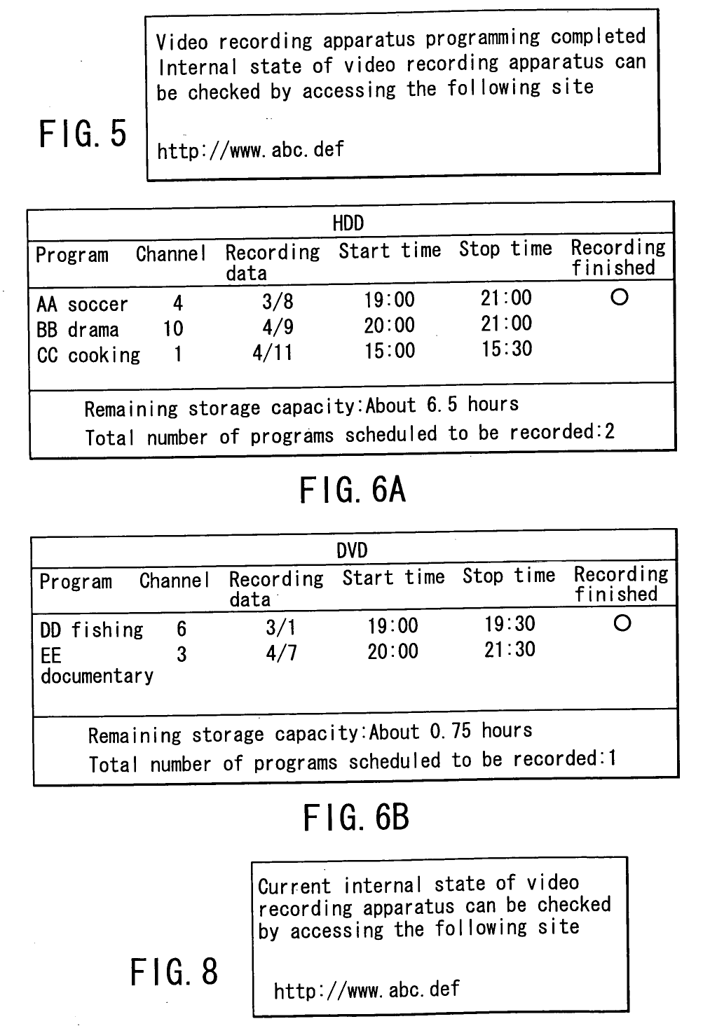

Then, the MPU 105 checks the management information of the temporary recording section 104b and the disk D or HDD 104d, and the programming information table 111a, acquires the internal state of the video recording apparatus 1 after registration of the video recording programming information, and transmits the data of the internal state to the Web server 4, and the Web server 4 updates the data of the internal state it has been storing (S18). In addition, the MPU 105 sends a notification to the user by e-mail about the completion of video recording apparatus programming by e-mail, and the URL of the Web server storing the data of the internal state (S19). FIG. 5 shows an example of the format of an e-mail sent when video recording programming by e-mail has successfully been performed. The flow then returns to step 10 of checking whether a new video recording apparatus programming e-mail is in the mailbox, and the above-described steps are repeated.

FIG. 6 shows examples of the internal state, the data of which is sent in step S15 or S18. Such internal state data includes a list of recording start and stop times of programs already recorded or scheduled to be recorded, the total number of programs scheduled to be recorded, and the amount of storage that remains available after all the scheduled recording has been carried out, and shows information with respect to the HDD 104d and the disk D loaded in the disk drive unit 104a. For example, when the video recording apparatus programming is not possible because a user has designated the DVD as the medium on which recording is to be done even though the DVD has little available storage and the HDD has sufficient amount of available storage, the user can immediately find out by receiving the data of the internal state that it is only necessary to change the medium on which recording is to be done to the HDD. On the other hand, a video recording apparatus usually imposes a limit to the number of programs that can be scheduled for recording, for example, ten programs. Even when there is a sufficient amount of available storage, programs cannot be scheduled for recording beyond that limit. Showing the total number of programs scheduled for recording as the internal status data allows the user to see how many more programs can be recorded, aside from the remaining amount of available storage.

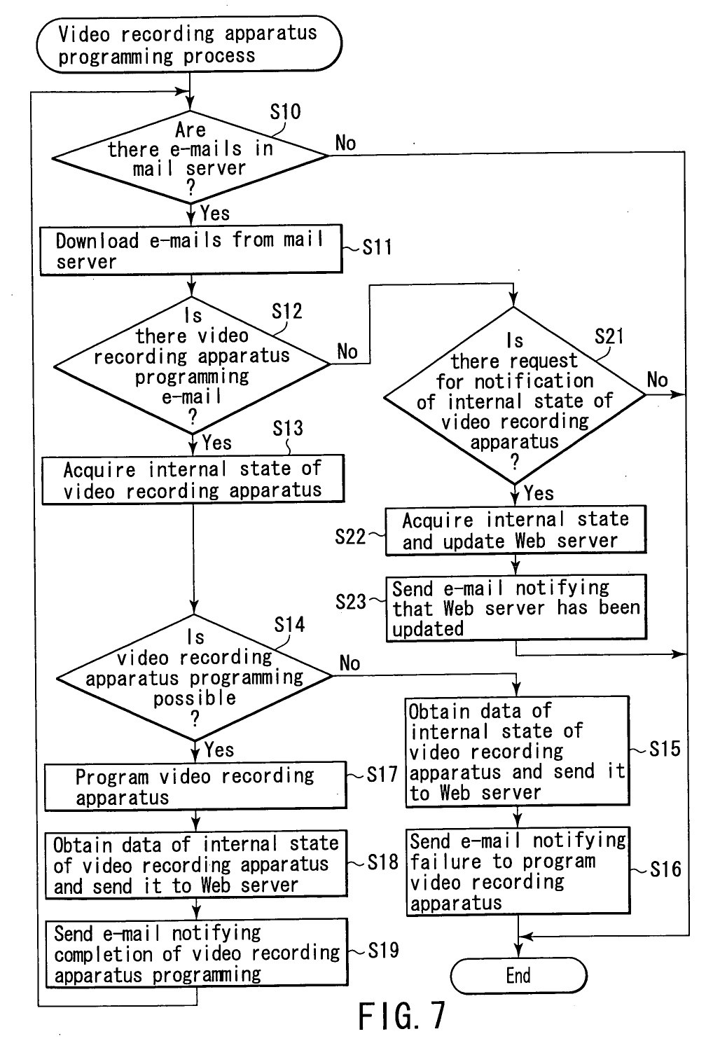

The above-described embodiment is characterized in that a user is notified of the internal state of the video recording apparatus 1 when the user programs the video recording apparatus 1 to record a program. However, the notification of the internal state of the video recording apparatus 1 needs not be restricted to the time when the user programs the video recording apparatus 1 to record a program; an embodiment in which a user sends an e-mail requesting to be notified only of the internal state of the video recording apparatus 1, and receives the data of the internal state from the Web server is also effective. FIG. 7 is a flowchart showing such an embodiment. As compared to the flowchart shown in FIG. 3, the flowchart shown in FIG. 7 has additional steps S21-S23. Checking the internal state of the video recording apparatus 1 by e-mail before video recording apparatus programming, as described in the flowchart, prevents a user from unnecessarily inputting programming information and sending an e-mail, for example, when the remaining amount of available storage of the video recording apparatus 1 is insufficiently little and video recording apparatus programming is not possible. FIG. 8 shows an example of the format of an e-mail sent to the portable terminal 3 when there has been a request for the transmission of the data of the internal state.

According to the present embodiment, because the data of the internal state of the video recording apparatus 1 is transferred to the Web server by the video recording apparatus 1 itself, as described above, a user can check the internal state of the video recording apparatus 1 any time as needed. Hence, the number of times a user fails to carry out video recording apparatus programming is reduced, and the communication charge can be prevented from increasing.

Another embodiment of the present invention will now be described.

The data of the internal state of the video recording apparatus can be directly transmitted to a user's portable terminal 3 without going through the Web server. Therefore, a user may select whether to have the data of the internal state sent to the portable terminal 3, or to have the data of the internal state sent to the Web server as in steps S15 and S18 shown in FIG. 3. The selection may be made using a video recording apparatus programming e-mail, which is sent from the portable terminal 3, or may be made in advance using the operation panel or remote control unit of the video recording apparatus 1. Alternatively, the data of the internal state may be stored as audio data in the Web server and a user may check the internal state through voice.

A yet another embodiment of the present invention will now be described.

Whether a user feels the need to know the internal state of the video recording apparatus 1 at the end of video recording apparatus programming changes with each video recording apparatus programming. For example, when programming the video recording apparatus 1 to record only one program, the user may feel that it is unnecessary to know the internal state of the video recording apparatus 1. However, when programming the video recording apparatus 1 to record more than one program, the user will often desire to know whether the video recording apparatus 1 can be programmed to record more programs at the end of the first programming.

To meet such needs, the video recording apparatus of the present embodiment is characterized in that a user can select whether to be notified of the internal state by e-mail or to have the data of the internal state transferred to the Web server. There are many selection methods, for example, the method of making the setting using an e-mail sent from the user at the time of video recording apparatus programming, the method by which the video recording apparatus is provided with a manual switch for selection, and the method of making the setting using the remote control unit.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A video recording apparatus that communicates with an external apparatus via a communication network, comprising:
a recording section which records a broadcast onto a recording medium;
a communication control section which controls communication via the communication network;
an acquisition section which acquires an internal state of the video recording apparatus; and
an internal state transmission section which transmits and stores data of the internal state, acquired by the acquisition section, into a server on the communication network using the communication control section, wherein the data of the internal state stored in the server is sent to a user in response to an instruction sent from the user via the communication network.

2. A video recording apparatus according to claim 1, further comprising:
a receiving section which receives programming information via the communication control section;
a judgment section which judges whether recording according to the received programming information is possible;
a registration section which registers the programming information received by the receiving section when it is judged that the recording is possible, wherein the acquisition section acquires the internal state after the registration of the programming information by the registration section, and the internal state transmission section transmits the data of the internal state acquired after the registration to the server;
an e-mail sending section which sends an e-mail indicating that the programming information has been registered, and an address of the server, to a portable terminal of the user via the communication control section; and
video recording apparatus programming section which controls the recording section to record based on the programming information registered by the registration section.

3. A video recording apparatus according to claim 2, wherein the e-mail sending section sends an e-mail indicating that video recording apparatus programming is impossible, to the user via the communication control section when the recording based on the programming information is impossible.

4. A video recording apparatus according to claim 3, wherein the e-mail sending section sends an e-mail indicating the address of the server, to the user via the communication control section when the recording based on the programming information is impossible.

5. A video recording apparatus according to claim 2, wherein the data of the internal state transmitted by the internal state transmission section includes one of a list of programs scheduled to be recorded and a list of recorded programs.

6. A video recording apparatus according to claim 2, wherein the data of the internal state transmitted by the internal state transmission section includes the number of programs scheduled for recording.

7. A video recording apparatus according to claim 2, wherein the portable terminal is one of a celluler telephone and a PHS (personal handy-phone system), and the internal state, the data of which is transmitted by the internal state transmission section, is notified by voice.

8. A video recording apparatus according to claim 2, wherein
the e-mail sending section includes a section which sends the data of the internal state acquired by the internal state acquisition section to the portable terminal of the user via the communication control section, and
the video recording apparatus further comprises a selection section for selecting which one of the e-mail sending section and the internal state transmission section sends the data of the internal state.

9. A video recording apparatus according to claim 2, wherein
the internal state transmission section transmits the date of the internal state to the server on the communication network using the communication control section upon receipt of an e-mail requesting the data of the internal state via the communication control section, and
the e-mail sending section sends an e-mail indicating the address of the server, to the portable terminal of the user via the communication control section.

10. A programming method applied to a video recording apparatus that communicates with an external apparatus via a communication network, comprising:
receiving programming information from a portable terminal of a user via the communication network;
judging whether recording is possible according to the received programming information;
registering the received programming information in the video recording apparatus when it is judged that the recording is possible;
acquiring an internal state of the video recording apparatus and transmitting data of the internal state to a server on the communication network;
sending an e-mail indicating that the programming information has been registered, and an address of the server, to the portable terminal of the user via the communication network; and
controlling a recording section to record based the registered programming information.

11. A programming method according to claim 10, further comprising sending an e-mail indicating that video recording apparatus programming is impossible, to the user via the communication network when the recording based on the programming information is impossible.

12. A programming method according to claim 10, further comprising sending an e-mail indicating the address of the server to the user via the communication network when the video recording based on the programming information is impossible.
